(19) United States
(12) Patent Application Publication
(10) Pub. No.: US 2025/0217140 A1
(43) Pub. Date: Jul. 3, 2025

(54) INFORMATION PROCESSING DEVICE, WARNING PRIORITY PREDICTION METHOD, AND STORAGE MEDIUM STORING WARNING PRIORITY PREDICTION PROGRAM

(71) Applicant: DENSO CORPORATION, Kariya-city (JP)

(72) Inventors: Hiroki KATO, Kariya-city (JP); Yuki MAE, Kariya-city (JP); Wenhung HUANG, Kariya-city (JP); Hidenori MATSUZAKI, Kariya-city (JP)

(21) Appl. No.: 18/989,618

(22) Filed: Dec. 20, 2024

(30) Foreign Application Priority Data
Dec. 28, 2023 (JP) 2023-223052

(51) Int. Cl. G06F 8/77; G06F 11/34

(52) U.S. Cl. CPC G06F 8/77; G06F 11/3428

(57) ABSTRACT

An information processing device that predicts a priority of a warning indicated by an analysis result of a source code by a static analysis tool is provided. The information processing device is configured to generate a prediction model, the prediction model being trained using machine learning with learning input data including the source code, warning information, product-specific information, and non-dependent information, and using a warning label associated with each warning as training data, with the analysis result of the static analysis tool for the source code as input and the priority of the warning as output, receive the analysis result, and predict the priority of the warning indicated by the analysis result.

### CROSS REFERENCE TO RELATED APPLICATION

This application is based on Japanese Patent Application No. 2023-223052 filed on Dec. 28, 2023, the disclosure of which is incorporated herein by reference.

### TECHNICAL FIELD

The present disclosure relates to an information processing device, a warning priority prediction method, and a warning priority prediction program.

### BACKGROUND

A related art describes an analysis device that prioritizes the static analysis result related to the source code under analysis based on the user's judgment results on whether to modify the source code corresponding to the static analysis result, information on source code metrics, and information on the program development project. The user's judgment result refers to the determination of true positive and false positive warnings. A true positive warning indicates a location where a violation genuinely exists, while a false positive warning incorrectly indicates a location where no violation exists. The user's judgment result indicating the true positive and false positive warnings is assigned to each warning as a warning label.

### SUMMARY

An information processing device that predicts a priority of a warning indicated by an analysis result of a source code by a static analysis tool is provided. The information processing device is configured to generate a prediction model, the prediction model being trained using machine learning with learning input data including the source code, warning information, product-specific information, and non-dependent information, and using a warning label associated with each warning as training data, with the analysis result of the static analysis tool for the source code as input and the priority of the warning as output, receive the analysis result, and predict the priority of the warning indicated by the analysis result.

### BRIEF DESCRIPTION OF THE DRAWINGS

Objects, features and advantages of the present disclosure will become more apparent from the following detailed description made with reference to the accompanying drawings. In the drawings:

FIG. 1 is a diagram illustrating the functional configuration of the warning priority prediction device according to an embodiment;

FIG. 2 is a schematic diagram illustrating an overview of the warning classification model according to the embodiment;

FIG. 3 is a schematic diagram illustrating the process of generating a warning classification model using information from multiple product projects according to the embodiment;

FIG. 4 is a schematic diagram illustrating the process of prioritizing a warning using the warning classification model according to the embodiment; and

FIG. 5 is a schematic diagram illustrating the process of generating a warning classification model using information from multiple product projects according to another embodiment.

### DETAILED DESCRIPTION

A static analysis tool has been used to analyze violation in source code. Although the analysis result from a static analysis tool includes numerous warnings, these warnings are a mix of a true positive warning and a false positive warning. A true positive warning indicates a location where a violation genuinely exists, while a false positive warning incorrectly indicates a location where no violation exists.

Therefore, a developer of source code has had to distinguish between a true positive warning and a false positive warning by oneself from the numerous warnings included in the analysis result of a static analysis tool.

In response to this, a related art describes an analysis device that prioritizes the static analysis result related to the source code under analysis based on the user's judgment results on whether to modify the source code corresponding to the static analysis result, information on source code metrics, and information on the program development project. The user's judgment result refers to the determination of true positive and false positive warnings. A true positive warning indicates a location where a violation genuinely exists, while a false positive warning incorrectly indicates a location where no violation exists. The user's judgment result indicating the true positive and false positive warnings is assigned to each warning as a warning label. The analysis device described in a related art prioritizes static analysis result based on information specific to the product project, resulting in priority rankings that depend on the product project. Therefore, when the analysis device is applied to the static analysis of source code from different product projects, the accuracy of the priority ranking of the static analysis result may decrease. Additionally, constructing an analysis device for each product project may increase development costs and other expenses.

Therefore, the present disclosure aims to provide an information processing device, a warning priority prediction method, and a warning priority prediction program that can accurately predict the priority of a warning from static analysis for different source codes used in different product projects.

According to one aspect of the present disclosure, an information processing device that predicts a priority of a warning indicated by an analysis result of a source code by a static analysis tool is provided. The information processing device includes: a learning unit configured to generate a prediction model, wherein the prediction model is trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output; a reception unit configured to receive the analysis result of the static analysis tool, which is a target of prediction by the prediction model; and a prediction unit configured to predict the priority of the warning indicated by the analysis result received by the reception unit, using the prediction model.

According to this configuration, a prediction model using machine learning with warning labels associated with each warning as training data is used to determine the priority of warning indicated by the analysis result of the source code by the static analysis tool. The warning label is assigned to each warning based on the user's judgment. The input data for learning the prediction model includes non-dependent information that does not depend on the product. As a result, the prediction model is generated as a versatile machine learning model, not specialized for specific source code or products. Therefore, this configuration can accurately predict the priority of warning indicated by the static analysis result for different source codes used in different product projects.

In the information processing device, the non-dependent information may include information regarding the type and settings of the static analysis tool used for analyzing the source code.

The performance of static analysis varies depending on the type and settings of the static analysis tool used for analyzing the source code. Therefore, by using information regarding the type and settings of the static analysis tool as input data for learning the prediction model, the priority of warning indicated by the static analysis result can be predicted with high accuracy. The type of static analysis tool includes different versions of the same type of static analysis tool. The settings of the static analysis tool may include, for example, the programming language standards.

In the information processing device, the non-dependent information may include characteristic information of the static analysis tool corresponding to the type of the static analysis tool. According to this configuration, by using the characteristic information of the static analysis tool as input data for learning the prediction model, warning from static analysis can be predicted with higher accuracy.

In the information processing device, the characteristic information may include at least one of the determinability of the static analysis and the benchmark evaluation result of the static analysis tool. According to this configuration, the priority of a warning indicated by the static analysis result can be predicted with high accuracy.

In the information processing device, the priority of the warning may be the probability of belonging to a specific warning label. According to this configuration, the user can easily recognize the location of the source code that need to be corrected.

In the information processing device, the warning labels may be multi-valued, including at least a true positive indicating a location with actual violation and a false positive indicating a location incorrectly warned as having violation. According to this configuration, the user can easily recognize the location of the source code that need to be corrected.

In the information processing device, the true positive may be divided into a warning that requires correction of the source code and a warning that does not require correction of the source code. According to this configuration, the user can easily recognize the location of the source code that need to be corrected.

In the information processing device, the prediction unit may input the analysis result of the source code, the source code, product-specific information using the source code, and non-dependent information into the prediction model to predict the priority of the warning indicated by the analysis result.

In the above information processing device, the prediction model may be generated by a machine learning model capable of ensemble learning.

According to one aspect of the present disclosure, a priority prediction method that predicts a priority of a warning indicated by an analysis result of a source code by a static analysis tool is provided. The priority prediction method includes: a first step of generating, by a learning unit, a prediction model trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output; a second step of receiving, by a reception unit, the analysis result of the static analysis tool, which is a target of prediction by the prediction model; and a third step of predicting, by a prediction unit, the priority of the warning indicated by the analysis result received by the reception unit, using the prediction model.

According to one aspect of the present disclosure, a warning priority prediction program that causes a computer included in an information processing device that predicts a priority of a warning indicated by an analysis result of a source code by a static analysis tool is provided. The program causes the computer to function as: a learning unit configured to generate a prediction model trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output; a reception unit configured to receive the analysis result of the static analysis tool, which is a target of prediction by the prediction model; and a prediction unit configured to predict the priority of the warning indicated by the analysis result received by the reception unit, using the prediction model.

According to the present disclosure, it is possible to accurately predict the priority of a warning from static analysis for different source codes used in different product projects.

Embodiments of the present disclosure will be described with reference to the drawings. The embodiments described below are examples of how the present disclosure can be implemented and are not intended to limit the present disclosure to the specific configurations described below. In implementing the present disclosure, specific configurations appropriate to the embodiments may be adopted as needed.

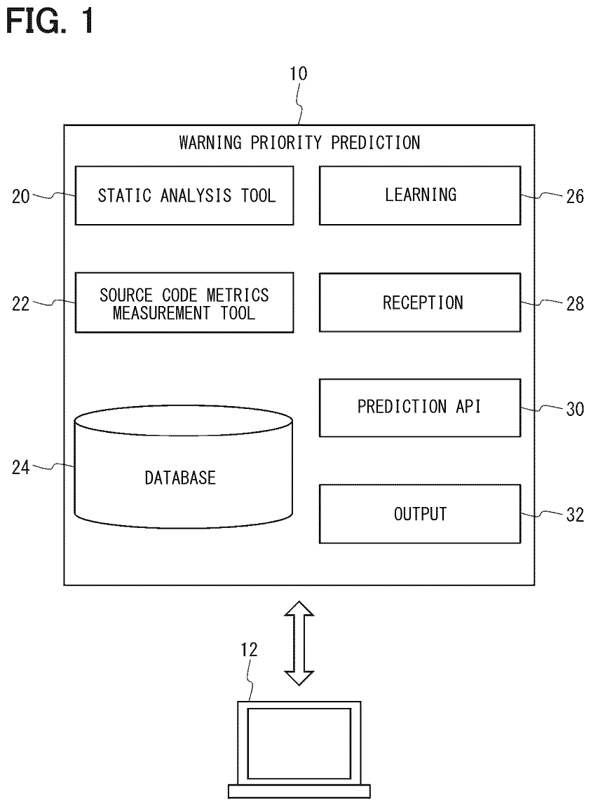

FIG. 1 is a diagram showing the functional configuration of the warning priority prediction device 10 according to the present embodiment. The warning priority prediction device 10 of this embodiment is an information processing device equipped with a CPU (Central Processing Unit) or other computing devices and can be accessed via a web browser from a user terminal 12.

The warning priority prediction device 10 classifies warnings indicated by the analysis result (corresponding to a static analysis result) of a source code by a static analysis tool 20 using a prediction model generated by machine learning and predicts the priority of the warning. The prediction model is referred to as the warning classification model.

The user terminal 12 is an information processing device such as a laptop or desktop personal computer and can access the warning priority prediction device 10. A user such as a software developer creates the source code for the software used in products using the user terminal 12.

A User sends the source code to the warning priority prediction device 10 from the user terminal 12 as needed according to the progress of the creation. The warning priority prediction device 10 analyzes the received source code using the static analysis tool 20 and outputs the analysis result.

The static analysis result includes a warning indicating the location of violation in the source code. The warning contains a mix of a true positive (TP), which indicates actual violation, and a false positive (FP), which incorrectly indicates violation where there is none. Therefore, it is necessary to determine whether each warning is a TP or an FP.

In response, the warning priority prediction device 10 of this embodiment classifies a warning indicated by the static analysis result into TP or FP using the warning classification model, thereby predicting the priority of the warning that a user should address. The warning priority prediction device 10 then sends the prediction result to the user terminal 12.

Furthermore, TPs can be further subdivided into a warning that requires correction of the source code (Confirmed) and a warning that does not require correction of the source code (Intentional). Therefore, the warning priority prediction device 10 may further classify TPs into a warning that requires correction and a warning that can be disregarded, and predict the priority of the warning.

In other words, the prediction by the warning classification model of this embodiment includes binary classification, which classifies the warning indicated by the static analysis result into TP and FP and outputs the probability of belonging to each, and ternary classification, which classifies the warning into a warning that requires correction, a warning that can be disregarded, and FP, and outputs the probability of belonging to each. Whether the prediction by the warning classification model is binary or ternary may be determined by the settings of the warning priority prediction device 10, or the warning priority prediction device 10 may have only one of these functions.

In binary classification, for example, the probability that a warning is a TP is predicted as 90% TP probability and 10% FP probability. In ternary classification, for example, for a given warning, the probability that the warning is a correction-required warning is predicted as 70% correction-required probability, the probability that the warning is a disregarded warning is predicted as 20% disregarded probability, and the probability that the warning is a false positive (FP) is predicted as 10% FP probability.

Thus, the warning priority prediction device 10 outputs the probability of belonging to a specific warning label as the priority of the warning. The specific warning labels are multi-valued, including at least TP and FP. In other words, the warning with a high TP probability or high correction-required probability is considered a high-priority warning. This allows a user to easily recognize the location of the source code that needs correction and prioritize the correction of code corresponding to the warning identified as high-probability TP.

A warning label such as TP, FP, correction-required warning, and disregarded warning is assigned to each warning. In the following description, the TP probability, FP probability, correction-required probability, and disregarded probability predicted by the warning classification model are collectively referred to as a prediction probability.

As shown in FIG. 1, the warning priority prediction device 10 of this embodiment includes a static analysis tool 20, a source code metrics measurement tool 22, a database 24, a learning unit 26, a reception unit 28, a prediction Application Programming Interface (API) 30, and an output unit 32.

The static analysis tool 20 statically analyzes the source code received from the user terminal 12 and outputs the static analysis result. The static analysis result includes a warning ID assigned to each warning to identify the violation in the source code. The static analysis result is stored in the database 24 associated with the analyzed source code.

The source code metrics measurement tool 22 measures the metrics of the source code received from the user terminal 12. The source code metrics are stored in the database 24 associated with the measured source code.

The database 24 stores input data for learning (referred to as “learning input data”) and training data used for training the warning classification model, which is a machine learning model, as well as the classification result of a warning using the warning classification model.

The learning unit 26 generates the warning classification model through machine learning using the learning input data and the training data stored in the database 24. The learning unit 26 updates the warning classification model as necessary when various data stored in the database 24 are added or updated.

The reception unit 28 receives the static analysis result to be predicted by the warning classification model. The static analysis result is the analysis result of the source code by the static analysis tool 20, and the warning is unclassified. The reception unit 28, in addition to receiving the unclassified warning indicated by the static analysis result, also receives various data necessary for determining the priority of the warning and derives these features.

The prediction API 30 deploys the warning classification model trained (learned) by the learning unit 26 and determines the priority of the warning indicated by the static analysis result received by the reception unit 28 using the warning classification model. In other words, the prediction API 30 functions as a classifier that outputs the predicted probability indicating the priority of the warning associated with the warning ID.

The output unit 32 sends the predicted probability for each warning, which is the prediction result of the warning classification model in the prediction API 30, to the user terminal 12.

The user terminal 12 displays the predicted probability for each warning output by the warning classification model in a viewer. The viewer can sort warnings by TP probability. Accordingly, the learning input data for generating the warning classification model is accumulated.

Additionally, if the predicted probability received from the warning priority prediction device 10 is deemed appropriate, the user assigns a warning label to the warning ID according to the predicted probability and sends back to the warning priority prediction device 10. Conversely, If the predicted probability received from the warning priority prediction device 10 is deemed inappropriate, the user assigns the warning label the user considers appropriate to the warning ID and sends back to the warning priority prediction device 10. The warning priority prediction device 10 stores the warning ID and a warning label received from the user terminal 12 in the database 24 associated with the static analysis result targeted by the warning classification model. This accumulates learning input data for generating the warning classification model.

In this manner, the warning priority prediction device 10 of this embodiment operates the warning classification model in conjunction with the static analysis tool 20. Therefore, it can collect labeled training data (training data) without requiring a user to perform annotation task for training the warning classification model through the machine learning.

While the warning priority prediction device 10 of this embodiment includes the learning unit 26, the functions of the learning unit 26 may be provided by another information processing device.

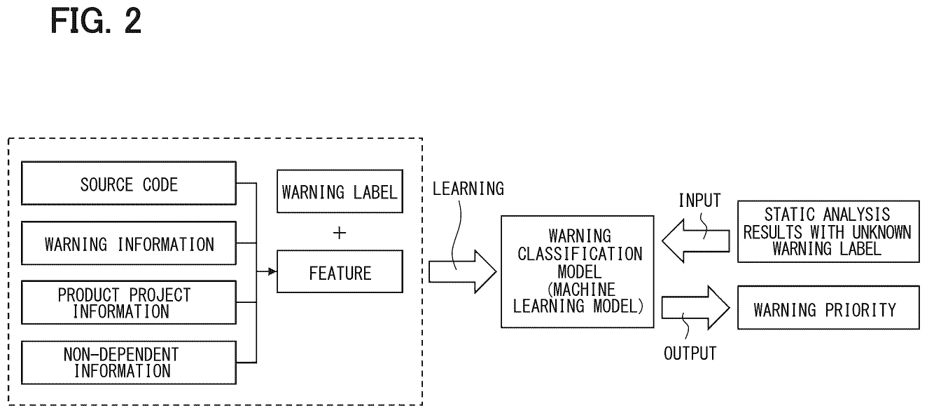

FIG. 2 is a schematic diagram showing an overview of the warning classification model according to this embodiment.

The warning classification model of this embodiment is a model in which a large number of weak learners that predict a warning label based on various conditions of the input data are generated when a warning indicated by the static analysis result is input and the prediction result of the probability of the warning label by these weak learners are aggregated into a single prediction value using methods such as majority voting or weighting to be outputted. Therefore, the warning classification model of this embodiment is generated through supervised learning using a machine learning model capable of ensemble learning, such as LightGBM.

The learning input data for generating the warning classification model of this embodiment through machine learning includes features based on source code, warning information, product project information, and non-dependent information (also referred to as independent information). The training data includes a warning label assigned to each warning indicated by the static analysis result based on the user's judgment.

The source code is the one analyzed by the static analysis tool 20. Instead of the source code itself, the learning input data may the number of lines of code and cyclomatic complexity included in metrics of the source code measured by the source code metrics measurement tool 22.

Here, the tendencies of the source code may vary depending on the product. Therefore, by using the source code or source code metrics as learning input data, the tendencies of different source codes for each product project are learned.

The warning information includes information on the occurrence location of warning in the source code indicated by the static analysis result. The warning label, which is the training data, is associated with the information.

The product project information is product-specific information using the source code, such as the product name or model number. The product project information may include other information representing the characteristics of the product project in addition to the product name. By using the product project information as learning input data, the tendency of a warning label for each product is learned.

The non-dependent information includes information that does not depend on the product. By using the non-dependent information that does not depend on the product as a learning input data, the warning classification model is generated as a versatile machine learning model, not specialized for specific source codes or products.

The non-dependent information in this embodiment includes information regarding the type and setting of the static analysis tool 20 used for analyzing the source code. The type of the static analysis tool 20 includes, for example, the name, product number, and version of the static analysis tool 20. The setting of the static analysis tool 20 include, for example, the standard of the programming language used to create the source code. The programming language standard includes, for example, whether the same C language conforms to C99 or not. The information regarding the type and setting of the static analysis tool 20 is referred to as tool information.

The performance of static analysis varies depending on the type and settings of the static analysis tool 20 used for analyzing the source code. Therefore, by using information regarding the type and settings of the static analysis tool 20 as learning input data, the warning label associated with the warning indicated by the static analysis result can be predicted with high accuracy regardless of the static analysis tool 20.

Additionally, the non-dependent information includes characteristic information of the static analysis tool 20. The characteristic information of the static analysis tool 20 includes at least one of the determinability of the static analysis and the benchmark evaluation result of the static analysis tool 20. The determinability of the static analysis refers to the determinability of the static analysis against rules such as MISRA corresponding to the warning output by the static analysis tool 20, indicating “determinable,” “indeterminable,” or “indeterminate” for each warning. The determinability and benchmark evaluation result are based on publicly available information from the manufacturer of the static analysis tool 20, generally known information, or information based on past experience.

The characteristic information of the static analysis tool 20 varies depending on the type and version of the static analysis tool 20 and is stored in the database 24 associated with the type and version of the static analysis tool 20. By using the characteristic information of the static analysis tool 20 as learning input data for the warning classification model, a warning from static analysis can be predicted with higher accuracy.

The learning unit 26 of this embodiment derives a feature based on the source code, warning information, product project information, and non-dependent information. An example of the derived feature is shown below. The derived features are not limited to the following, and it is not necessary to use all of the following features:
the name (URL) of the source code base where the source code with the warning is managed;
the path to the source code file where the warning occurred;
the name of the source code file where the warning occurred;
the function name in the source code where the warning occurred;
the line number in the source code where the warning occurred;
the ID representing the type of warning;
the severity of the warning;
the name of the static analysis tool 20 that generated the warning;
the version of the static analysis tool 20 that generated the warning;
the determinability of the static analysis against rules such as MISRA corresponding to the warning;
the benchmark evaluation result of the static analysis tool 20 against rules such as MISRA corresponding to the warning;
the number of warnings in the function of the source code where the warning occurred;
the number of warnings in the source code file where the warning occurred;
the elapsed time since the warning occurred;
the file-level source code metrics of the source code file where the warning occurred;
the function-level source code metrics of the source code file where the warning occurred; and
the name of the product project where the warning occurred.

The learning unit 26 of this embodiment uses the above features as learning input data and generates the warning classification model through machine learning using the warning label assigned to each warning indicated by the static analysis result based on the user's judgment as training data. Such a combination of a feature and a warning label constitute a single training dataset. In other words, the more training datasets there are, the higher the accuracy of the warning classification model.

The prediction API 30 inputs the static analysis result of the source code, the source code, product project information, and non-dependent information into the warning classification model and outputs the predicted probability of the warning label indicating the priority of the warning indicated by the static analysis result.

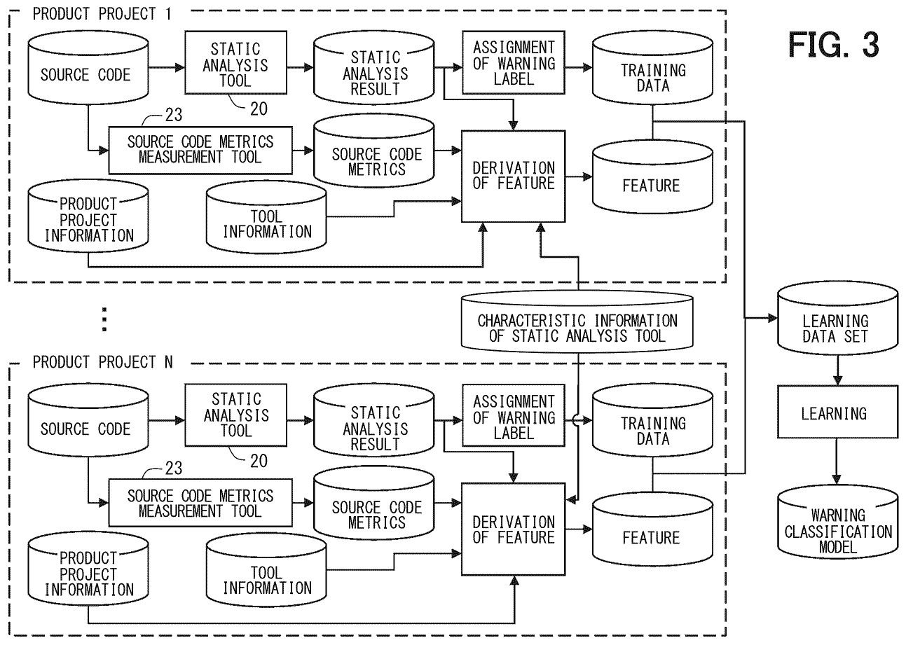

FIG. 3 is a schematic diagram showing the process of generating a warning classification model using information from multiple product projects 1 to N according to this embodiment. The process of generating the warning classification model is executed by a program stored in a storage medium such as a storage unit provided in the warning priority prediction device 10. When the program is executed, the method corresponding to the program is carried out.

As shown in FIG. 3, the feature, which is the learning input data, is derived by the learning unit 26 based on the source code metrics, static analysis result, product project information, tool information, and characteristic information of the static analysis tool 20 for each product project 1 to N.

The characteristic information of the static analysis tool 20 is stored in the database 24 as common information regardless of the product project. The characteristic information of the static analysis tool 20 corresponding to the name and version indicated by the tool information is read from the database 24.

Additionally, the warning label assigned to the warning indicated by the static analysis result of the source code for each product project 1 to N is used as training data.

The learning datasets, which are combinations of a feature and training data for each product project 1 to N, are stored in the database 24. The learning datasets are generated each time the source code for each product project 1 to N is modified or improved, stored in the database 24, and used for subsequent learning of the warning classification model. The learning unit 26 generates the warning classification model through machine learning using a large number of learning datasets.

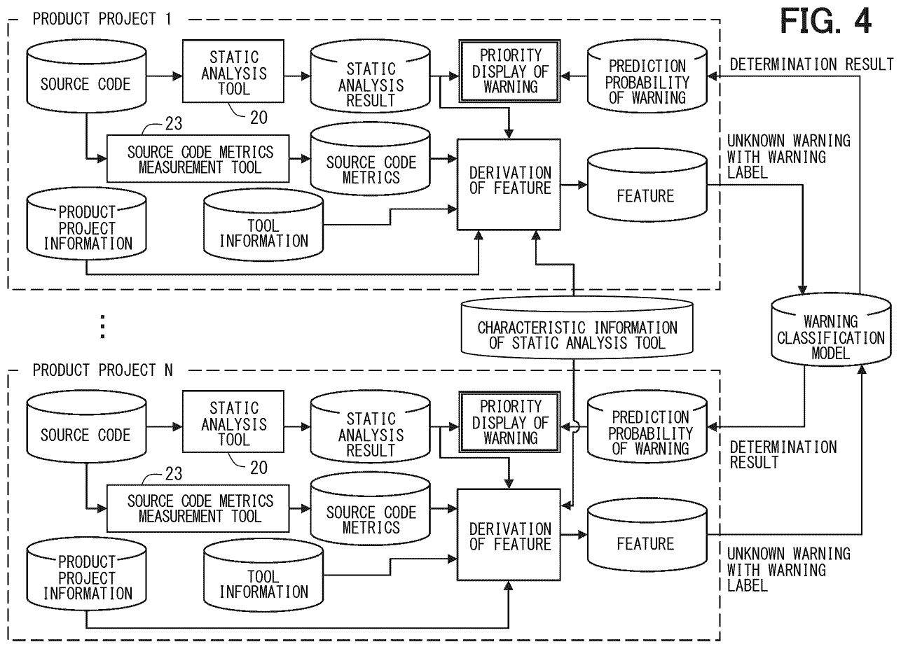

FIG. 4 is a schematic diagram showing the process of prioritizing a warning using the warning classification model according to this embodiment. The process of prioritizing a warning is executed by a program stored in a storage medium such as a storage unit provided in the warning priority prediction device 10. When this program is executed, the method corresponding to the program is carried out.

The process of prioritizing a warning is carried out when the user sends the source code to the warning priority prediction device 10 via the user terminal 12 and issues an instruction to execute static analysis. According to this instruction, the static analysis tool 20 first performs static analysis of the source code and outputs the static analysis result. Additionally, the source code metrics measurement tool 22 measures the source code metrics of the source code.

The reception unit 28 reads the product project information, tool information, and characteristic information of the static analysis tool 20 corresponding to the source code from the database 24. Based on the read information, the static analysis result, and the source code metrics, the reception unit 28 derives the feature. The feature includes a warning indicated by the static analysis result with an unknown warning label.

By inputting the feature into the warning classification model, the warning classification model outputs the predicted probability of the warning as prediction result. The predicted probability of the warning is stored in the database 24 and sent to the user terminal 12. The user confirms the location of the source code that need correction by checking the predicted probability of the warning sent to the user terminal 12 using a viewer.

As mentioned above, if the predicted probability is deemed appropriate, the user assigns a warning label to the warning ID according to the predicted probability and sends back to the warning priority prediction device 10. If the predicted probability is deemed inappropriate, the user assigns a warning label to the warning ID based on one's judgment and sends back to the warning priority prediction device 10. The warning priority prediction device 10 stores the warning ID and warning label received from the user terminal 12 in the database 24 associated with the static analysis result. The warning label stored in the database 24 in this manner is used as training data.

In FIG. 4, the static analysis result of the source code for product projects 1 to N is the prediction target of the warning classification model, but the static analysis result of the source code other than product projects 1 to N may also be the prediction target of the warning classification model.

Additionally, the warning priority prediction device 10 of this embodiment may update the warning classification model through machine learning using newly stored learning dataset in the database 24. The timing of the update may be, for example, when the performance degradation of the warning classification model becomes apparent or when a predetermined number of new learning datasets have been accumulated. The performance degradation of the warning classification model may be a case, for example, when the frequency of a warning label assigned by the user differing from the predicted probability of the warning classification model exceeds a predetermined value.

Furthermore, by updating the warning classification model, the predicted probability is determined by different versions of the warning classification model. Therefore, the viewer displayed on the user terminal 12 can filter the prediction results of the predicted probability for the warning by the version of the warning classification model.

As described above, the warning priority prediction device 10 of this embodiment uses non-dependent information that does not depend on the product using the source code as learning input data for the warning classification model. This increases the versatility of the warning classification model, allowing the prediction of warning priorities for different source codes used in different product projects with a single warning classification model.

In other words, without using non-dependent information, it would be necessary to generate a warning classification model for each product project. On the other hand, by generating the warning classification model using non-dependent information as in this embodiment, it is not necessary to generate a warning classification model for each product project, thereby minimizing the cost of generating and operating the warning classification model. Additionally, the number of learning datasets used to generate the warning classification model increases, which can be expected to improve performance.

Although the present disclosure has been described using the above embodiments, the technical scope of the present disclosure is not limited to the range described in the above embodiments. Various changes or improvements can be made to the above embodiments without departing from the gist of the disclosure, and such changes or improvements are also included in the technical scope of the present disclosure.

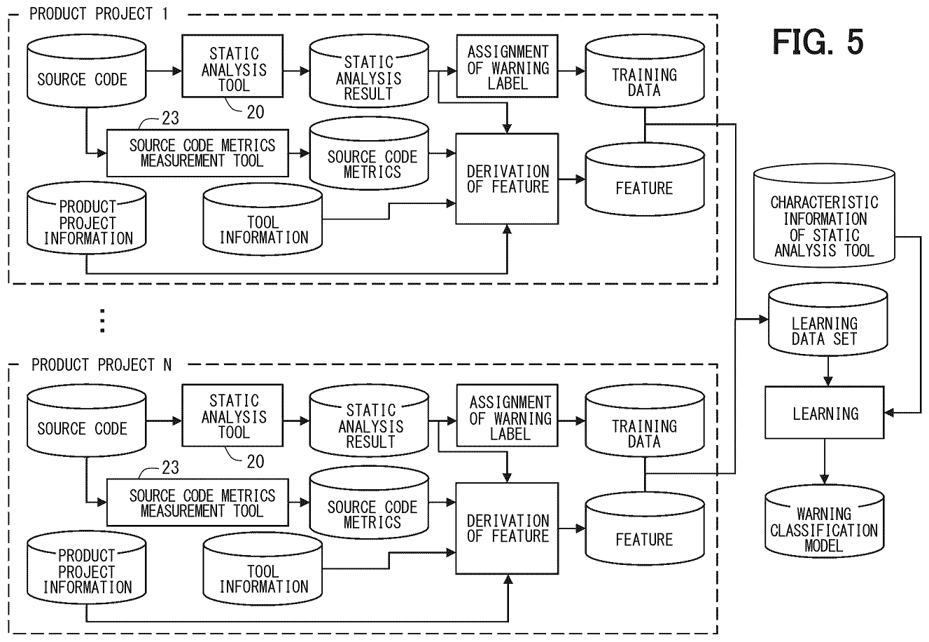

In the above embodiments, the characteristic information of the static analysis tool 20 is used to derive features, but the present disclosure is not limited to this. As shown in FIG. 5, the characteristic information of the static analysis tool 20 may not be used to derive features for each product project 1 to N. In this case, the warning classification model is trained using the features for each product project 1 to N and the characteristic information of the static analysis tool 20.

In the above embodiments, the source code metrics are used to derive features, but the present disclosure is not limited to this. Features may be derived using the source code itself instead of the source code metrics.

In the above embodiments, features are derived based on the learning input data, and the features are used for training the warning classification model, but the present disclosure is not limited to this. The warning classification model may be trained using the learning input data itself instead of the features.

In the above embodiments, the warning label for which the predicted probability is obtained by the warning classification model is described as binary (TP and FP) or ternary (correction-required warning, disregarded warning, and FP), but the present disclosure is not limited to this. The TP may be subdivided into three or more types, and the warning labels may be four or more values.

In the above embodiments, the non-dependent information is described as information related to the static analysis tool 20, but the present disclosure is not limited to this. The non-dependent information may be other information that does not depend on the product used for developing the source code. For example, information related to the source code metrics measurement tool 22 (such as the name and version of the tool) may be used in addition to the information related to the static analysis tool 20. Controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

What is claimed is:

1. An information processing device that predicts a priority of a warning indicated by an analysis result of a source code by a static analysis tool, the information processing device comprising:
a learning unit configured to generate a prediction model, wherein the prediction model is trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output;
a reception unit configured to receive the analysis result of the static analysis tool, which is a target of prediction by the prediction model; and
a prediction unit configured to predict the priority of the warning indicated by the analysis result received by the reception unit, using the prediction model.

2. The information processing device according to claim 1, wherein
the non-dependent information includes information regarding a type and settings of the static analysis tool used for analyzing the source code.

3. The information processing device according to claim 2, wherein
the non-dependent information includes characteristic information of the static analysis tool corresponding to the type of the static analysis tool.

4. The information processing device according to claim 3, wherein
the characteristic information includes at least one of a determinability of a static analysis and a benchmark evaluation result of the static analysis tool.

5. The information processing device according to claim 1, wherein
the priority of the warning is a probability of belonging to a specific warning label.

6. The information processing device according to claim 5, wherein
the warning label is multi-valued and include at least a true positive, which indicates a location with an actual violation, and a false positive, which indicates a location incorrectly warned as having a violation.

7. The information processing device according to claim 6, wherein
the true positive is divided into a warning that requires correction of the source code and a warning that does not require correction of the source code.

8. The information processing device according to claim 1, wherein
the prediction unit inputs the analysis result of the source code, the source code, product-specific information using the source code, and non-dependent information into the prediction model to predict the priority of the warning indicated by the analysis result.

9. The information processing device according to claim 1, wherein
the prediction model is generated by a machine learning model capable of ensemble learning.

10. A priority prediction method that predicts a priority of a warning indicated by an analysis result of a source code by a static analysis tool, the priority prediction method comprising:
a first step of generating, by a learning unit, a prediction model trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output;
a second step of receiving, by a reception unit, the analysis result of the static analysis tool, which is a target of prediction by the prediction model; and
a third step of predicting, by a prediction unit, the priority of the warning indicated by the analysis result received by the reception unit, using the prediction model.

11. A non-transitory computer readable storage medium storing a warning priority prediction program that causes a computer included in an information processing device that predicts a priority of a warning indicated by an analysis result of a source code by a static analysis tool, to function as:
a learning unit configured to generate a prediction model trained using machine learning with learning input data including the source code, warning information including a location of a warning in the source code indicated by the analysis result, product-specific information using the source code, and non-dependent information that does not depend on the product, and using a warning label associated with each warning as training data, with the analysis result of the static analysis tool for the source code as input and the priority of the warning as output;
a reception unit configured to receive the analysis result of the static analysis tool, which is a target of prediction by the prediction model; and
a prediction unit configured to predict the priority of the warning indicated by the analysis result received by the reception unit, using the prediction model.
